(19) United States
(12) Patent Application Publication
(10) Pub. No.: US 2023/0256450 A1
(43) Pub. Date: Aug. 17, 2023

(54) REAGENT CONTAINER FOR TRANSPORT

(71) Applicant: Omega Bio-tek, Inc., Norcross, GA (US)

(72) Inventors: Steven Cupello, Norcross, GA (US); Travis Butts, Norcross, GA (US); Julie Baggs, Norcross, GA (US); Qi Guo, Norcross, GA (US)

(73) Assignee: Omega Bio-tek, Inc., Norcross, GA (US)

(21) Appl. No.: 18/109,107

(22) Filed: Feb. 13, 2023

Related U.S. Application Data
(60) Provisional application No. 63/309,757, filed on Feb. 14, 2022.

(51) Int. Cl. B01L 3/00

(52) U.S. Cl. CPC B01L 3/52; B01L 2200/16; B01L 2200/185; B01L 2200/0689; B01L 2300/12

(57) ABSTRACT

A unique novel reagent container device with a unique grid structure that allows for the sealing of liquids including volatile liquids. The reagent container device of the present disclosure comprises a container that can be sealed and a support system that forms a grid for sealing the top of the container. Such support system does not restrict liquid flow nor forms an additional section or well within the container device.

### CROSS-REFERENCE TO RELATED APPLICATIONS

This application claims the benefit of U.S. Provisional Application No. 63/309,757, filed on Feb. 14, 2022, which is incorporated herein by reference in its entirety.

### FIELD AND BACKGROUND

The present disclosure relates generally molecular biology. Containers are utilized in a variety of handling fluids and are used in facilities including medical laboratories and research laboratories. Containers are commonly used in liquid handling robotics to hold liquid or reagents for the robotics. The reagent commonly is poured into the container by technicians operating the robotics. The containers are commonly manufactured out of polypropylene and polyethylene to be disposable. The robotics have a variety of liquid handling options that range from 1 pipetting heads to 384 pipetting heads. All the pipetting heads are commonly formatted into a society of biomolecular screening (SBS) format. It is desirable that the reagent can be poured into one area then fill the whole container without having to pour into multiple wells/or sections. At this time, there are number of commercially available containers which can be filled by the technician or containers that can be sealed that contain smaller sections or wells.

### SUMMARY

The present disclosure provides a unique novel reagent container with a unique grid structure that allows for the sealing of liquids including volatile liquids, such as ethanol and isopropanol. In certain embodiments, the reagent container of the present disclosure is a disposable container constructed of plastic material, such as high-density polyethylene (HDPE), low density polyethylene (LDPE), and/or other materials for any containers suitable for use with chemicals.

In certain embodiments, the reagent container device of the present disclosure comprises a) a container that can be sealed and b) a support system that forms a grid for sealing the top of the container, wherein the support system does not restrict liquid flow in the container nor form a well or section within the container device. In certain embodiments, the container device is capable of storing reagents, and can be filled with reagents prior to sealing. In certain embodiments, the container device can be accessed by 96-pipet tips in the Society for Biomolecular Screening (SBS) format simultaneously. In other embodiments, the container device is dimensions compatible with society of biomolecular screening.

In certain embodiments, the support system grid can be sealed with adhesive and/or heat-sealing tape and/or film. In other embodiments, seal can withstand chemical solvents such as ethanol or isopropanol; seal can also withstand stand transport from conventional shipping conditions; and seal is removable.

Other systems, methods, features, and advantages of the present disclosure will be or become apparent to one with skill in the art upon examination of the drawings and the descriptions provided herewith. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A & 1B. illustrate the angle view of the reagent container.

FIGS. 2A & 2B illustrate the top view of the reagent container.

FIGS. 3A-3C illustrate various views of the reagent container.

FIGS. 4A & 4B illustrate the angle and top view of the reagent container when it is sealed.

FIG. 5 illustrates the top view of the reagent container showing additional contact points after the seal is removed.

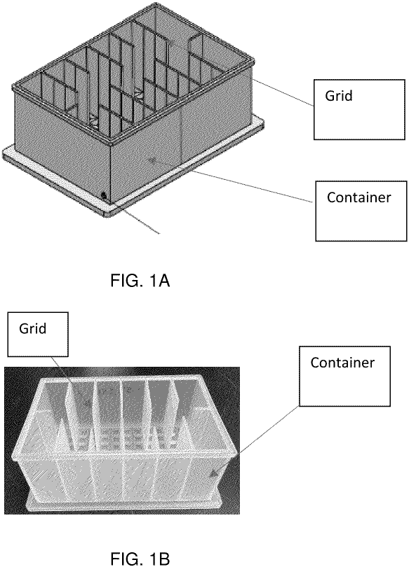

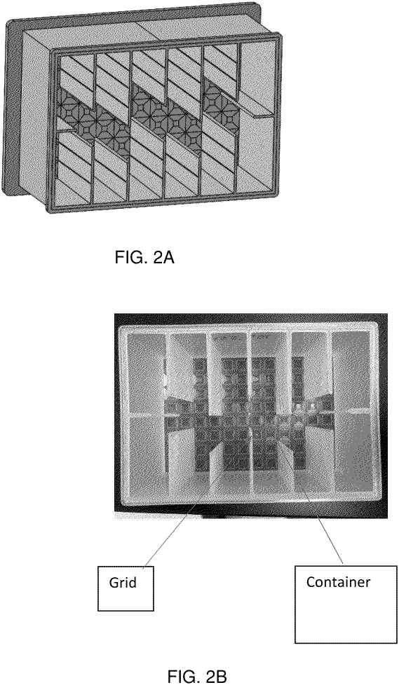

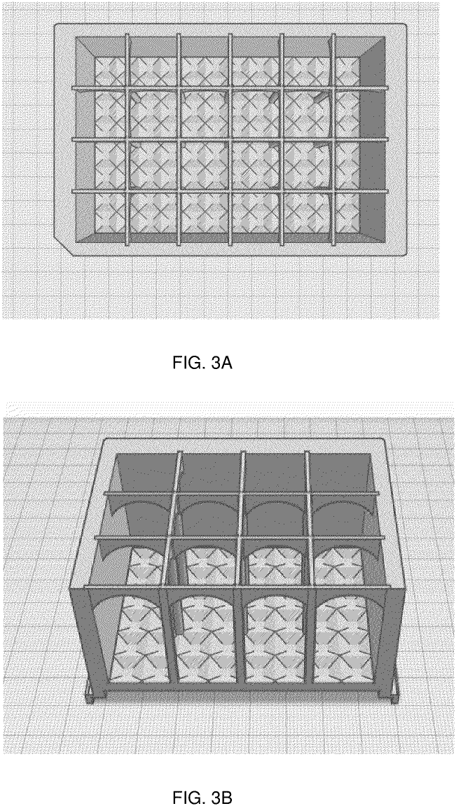

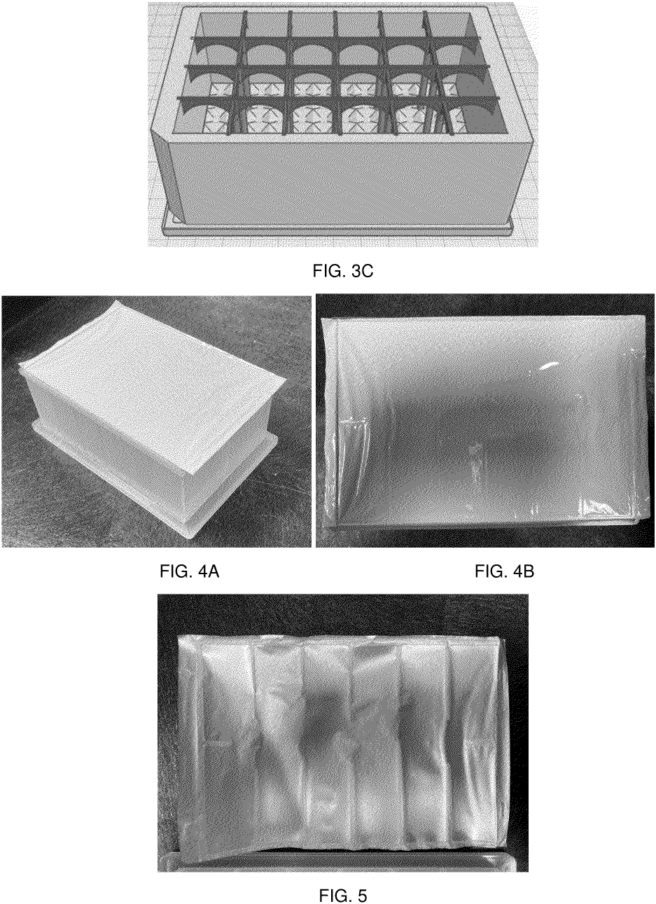

Additional advantages of the disclosed reagent container will be set forth in part in the description which follows, and in part will be obvious from the description, or can be learned by practice of the disclosed reagent container. The advantages of the reagent container of the present disclosure will be realized and attained by means of the elements and combinations particularly pointed out in the appended claims. It is to be understood that both the foregoing general description and the following detailed description are exemplary and explanatory only and are not restrictive of the disclosed and claimed reagent container, and technologies associated therewith.

### DETAILED DESCRIPTION

The present disclosure provides a unique novel reagent container device as disclosed herein. More specifically, the present disclosure provides a unique reagent container device having a unique grid structure that allows for the sealing of liquids including volatile liquids, such as ethanol and isopropanol. Volatile liquids create vapor pressure due to heating and cooling of liquids. The additional vapor pressure causes stress upon the seals. In certain embodiments, the reagent container device of the present disclosure comprises a grid design across to the top of the container that increases the surface area for adhesion by sealing mechanisms. In certain embodiments, the grid design also decreases the spacing between supports for the sealing film and facilitates a stronger seal.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, the term “container” refers to a device or a section or compartment part of the device that is used to store or hold a volume of a liquid. A container device can be composed of one single section or compartment. A container device can also be composed of multiple wells, sections or compartments, such as 12-, 24- and/or 96-wells, sections or compartments.

As used herein, the term “well” refers to a small, individual compartment within a container. As used herein, the term “section” refers to an individual compartment within a container.

As used herein, the term “well”, “section” and/or “compartment” can be used interchangeably. In certain embodiments, the term “well”, “section” and/or “compartment” may also be used interchangeably with the term “container” and/or “reservoir”.

As used herein, the term “reagent” refers to a substance used in chemical reactions commonly in a liquid form.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x′, less than y’, and ‘less than z’. Likewise, the phrase ‘about x, y, z, or greater’ should be interpreted to include the specific ranges of ‘about x’, ‘about y’, and ‘about z’ as well as the ranges of‘greater than x′, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a short chain fatty acid refers to an amount that is sufficient to achieve the desired improvement in the property modulated by the formulation component, e.g., achieving the desired level of reduction of withdrawal symptoms. The specific level in terms of wt% in a composition required as an effective amount will depend upon a variety of factors including the amount and type of short chain fatty acid, amount and type of carnitine derivative, amount and type of pharmaceutically acceptable excipients, and disorder being treated using the disclosed compositions.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the containers, devices, reagents, and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in °C or is at ambient temperature, and pressure is at or near atmospheric.

### Sealable Reagent Container

Current Market: The container with one (1)-sections or wells and the container with twelve (12)-sections or wells are two examples in the current market. For the one (1)-section container, its lack of contact points cannot withstand shipping and vapor pressure from volatile solvents due to temperature changes. Contact points with seal are only on the exterior of the container. Distance from seal contact point can exceed 24 mm. Contact distance with seal is ~ 428 mm. For the twelve (12)-section container, such as the 12-section container Omega Bio-tek provides, it does not divide liquid and form individual sections and therefore customers do not need to pour liquid to each individual section. Distance from seal contact point is < 24 mm.

The current market also has ninety-six (96)-section container with 96-, 24- and 12-individual sections within the container that can be sealed. However, this container does not allow for flow of liquid or volumes exceeding 200 mL.

### New Products

Customer Purpose: To offer customers the ability to purchase liquids pre-filled into a container device for their convenient use. Eliminates the need to transfer liquids from bottles to sections or compartments. This also allows for barcoding at manufacturing site which can be used to ensure proper setup. Seal can be applied to the container device multiple times. Plasticware is industry standard (SBS) length, and width.

Designs: Figures presented herewith the present disclosure provide several views of the unique reagent container device described herein. The design of the reagent container device presented herein does not create additional section or well within the container while allowing maximum 18 mm from seal contact point.

Unique aspect: The unique reagent container described herein contains only one (1) section container and does not restrict liquid flow, while grid pattern does not allow for more than 8-24 mm distance from contact points for seal. Greater than 200 mL liquid can be placed in container without restricting flow of liquid. Sealable options are available on market but require smaller or more sections. Plasticware material for the unique reagent container includes, but not limited to, high density polyethylene (HDPE) or low density polyethylene (LDPE), or Polystyrene.

Certain advantages of the unique reagent container disclosed herein include, but not limited to, a) reduction in spacing between contact points allows for seal to withstand shipping and vapor pressures from volatile solvents; b) unique design allows for flow of liquid not to be restricted by additional contact points; c) contact points are not more than 8-24 mm apart without limiting liquid flow; and d) the contact length with seal can be increased to, e.g., 726 mm.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A reagent container device comprises:
a) a container that can be sealed, and
b) a support system that forms a grid for sealing the top of the container, wherein the support system does not restrict liquid flow in the container.

2. The reagent container device of claim 1, wherein the container device is disposable.

3. The reagent container device of claim 1, wherein the container device is constructed of a plastic material.

4. The reagent container device of claim 3, wherein the plastic material is high density polyethylene (HDPE) or low density polyethylene (LDPE).

5. The reagent container device of claim 1, wherein the container device is capable of storing reagents.

6. The reagent container device of claim 1, wherein the container device is filled with reagents prior to sealing.

7. The reagent container device of claim 1, wherein the container device is accessed by 96- pipet tips in the Society for Biomolecular Screening (SBS) format simultaneously.

8. The reagent container device of claim 1, wherein the container device is dimensions compatible with society of biomolecular screening.

9. The reagent container device of claim 1, wherein the container device is composed of a single section or compartment.

10. The reagent container device of claim 1, wherein the container device is composed of multiple sections or compartments.

11. The reagent container device of claim 1, wherein the support system grid is sealed with adhesive tape and/or film.

12. The reagent container device of claim 1, wherein the support system grid is sealed with heating-sealing tape and/or film.

13. The reagent container device of claim 1, wherein seal can withstand chemical solvents.

14. The reagent container device of claim 13, wherein the chemical solvent is ethanol or isopropanol.

15. The reagent container device of claim 1, wherein seal can withstand stand transport from conventional shipping conditions.

16. The reagent container device of claim 1, wherein seal is removable.

17. The reagent container device of claim 1, wherein the grid does not create additional section or well within the container device.

18. The reagent container device of claim 1, wherein greater than 200 mL liquid can be placed in the container without restricting flow of liquid.

19. The reagent container device of claim 1, wherein a maximum 18 mm is allowed from a seal contact point.

20. A method of using the reagent container device of claim 1 for storing and transporting one or more reagents with or without a biological sample.
